(19) United States
(12) Patent Application Publication
(10) Pub. No.: US 2021/0390795 A1
(43) Pub. Date: Dec. 16, 2021

(54) Distributed System

(71) Applicant: Hitachi, Ltd., Tokyo (JP)

(72) Inventors: Tadanobu TOBA, Tokyo (JP); Takumi UEZONO, Tokyo (JP); Yutaka UEMATSU, Tokyo (JP); Kenichi SHIMBO, Tokyo (JP)

(21) Appl. No.: 17/342,018

(22) Filed: Jun. 8, 2021

(30) Foreign Application Priority Data
Jun. 10, 2020 (JP) 2020-100646

(51) Int. Cl. G07C 5/00; G07C 5/08; G06Q 10/00

(52) U.S. Cl. CPC G07C 5/008; G06Q 10/20; G07C 5/0808; G07C 5/006

(57) ABSTRACT

A distributed system includes an edge device, which is a moving body or equipment capable of automatic operation, and a diagnostic data computer. The edge device includes a moving mechanism or an operating mechanism for automatic operation, and an in-edge controller that controls the moving mechanism or the operating mechanism. Here, the diagnostic data computer: receives diagnostic data indicating an internal state in the in-edge controller.

### BACKGROUND OF THE INVENTION

### 1. Field of the Invention

The present invention relates to a distributed system including an edge device, which is a moving body or equipment capable of automatic operation.

### 2. Description of Related Art

JP-A-2010-55545 discloses a system that classifies an abnormal state before collating with a past defect database based on the state data when an abnormality occurs in a vehicle (one of the edge devices), and then searches and analyzes only the portions related to the classification in the defect database. In that system, the load on the vehicle side can be reduced without lowering the accuracy in the abnormality cause discrimination by performing the classification of the abnormal state on the vehicle side, transmitting the classification data to the center, and performing detailed analysis on the center side.

It is conceivable that the controller in the edge device that controls the moving mechanism in the moving body represented by the motor or the operating mechanism in the equipment represented by the hydraulic pressure will be complicated in order to realize the moving body capable of automatic operation. In this case, the controller in the edge device can take various kinds of internal states. Also, the resolution of these internal states (particularly abnormal states) is not limited to the kind of internal state that can be recovered only inside an edge device 12.

However, in JP-A-2010-55545, since the internal state (particularly abnormal state) of the ECU (one of the controllers in the edge device) per se is not transmitted to the outside of the edge device, the internal state cannot be dealt with in cooperation with the computer outside the edge device.

An object of the present invention is to provide a technique for dealing with the internal state of a controller in an edge device by cooperating the edge device with a computer outside the edge device.

### SUMMARY OF THE INVENTION

The present application includes a plurality of means for solving at least a part of the above problems and examples thereof are as follows.

The distributed system from a first viewpoint includes an edge device, which is a moving body or equipment capable of automatic operation, a diagnostic data computer, and a manufacturing company computer, which is a computer owned by a manufacturing company of the edge device. The edge device includes a moving mechanism or an operating mechanism for automatic operation and an in-edge controller that controls the moving mechanism or the operating mechanism. Here, the diagnostic data computer: receives diagnostic data indicating the internal state in the in-edge controller, performs a cause analysis process of the state in the in-edge controller based on the diagnostic data, and transmits the data after the cause analysis process or improved data for the edge device based on the result of the cause analysis process to the manufacturing company computer.

The distributed system from a second viewpoint includes an edge device, which is a moving body or equipment capable of automatic operation, a service provider computer, which is a computer of a company that provides a predetermined service, and an analysis outsourcing computer. The edge device includes a moving mechanism or an operating mechanism for automatic operation and an in-edge controller that controls the moving mechanism or the operating mechanism. Here, the analysis outsourcing computer: performs a service-related analysis process, which is an analysis process related to a predetermined service, based on the state of the in-edge controller, and transmits the data after the service-related analysis process obtained by the service-related analysis process to the service provider computer.

The distributed system from a third viewpoint includes an edge device, which is a moving body or equipment capable of automatic operation, a diagnostic data management computer, an analysis outsourcing computer, an edge data distribution company computer, and a service provider computer, which is a computer of a company that provides a predetermined service. The edge device includes a moving mechanism or an operating mechanism for automatic operation and an in-edge controller that controls the moving mechanism or the operating mechanism.

Here, the diagnostic data management computer: receives diagnostic data indicating the state in the in-edge controller, transmits the diagnostic data to the edge data distribution company computer, and transmits the diagnostic data to the analysis outsourcing computer according to a first schedule.

The edge data distribution company computer: receives diagnostic data from the diagnostic data management computer, stores the diagnostic data in a storage resource, processes the diagnostic data stored in the storage resource according to a second schedule having an interval longer than the first schedule, and transmits the processed diagnostic data to the service provider computer.

The analysis outsourcing computer: performs a service-related analysis process, which is an analysis process related to a predetermined service, based on the state of the in-edge controller, and transmits the data after the service-related analysis process obtained by the service-related analysis process to the service provider computer.

The distributed system from a fourth viewpoint includes an edge device, which is a moving body or equipment capable of automatic operation, a diagnostic data computer, and a manufacturing company computer, which is a computer owned by a manufacturing company of the edge device. The edge device includes a moving mechanism or an operating mechanism for automatic operation and an in-edge controller that controls the moving mechanism or the operating mechanism. Here, the diagnostic data calculator: receives diagnostic data indicating the internal state in the in-edge controller, and transmits the diagnostic data or the processed diagnostic data to another computer.

According to the present invention, it is possible to deal with the internal state of a controller in an edge device by cooperating the edge device with the computer outside the edge device.

Problems, configurations, and effects other than those described above will be clarified by the descriptions of the following embodiments.

### BRIEF DESCRIPTION OF THE DRAWINGS

FIG. 1 is a diagram showing a configuration example of an outline of a distributed system;

FIG. 2 is a diagram showing an outline of a configuration example of an edge device;

FIG. 3 is a diagram showing an example of a computer hardware configuration;

FIG. 4 is a diagram showing an outline of a configuration example of an edge device manufacturing company computer;

FIG. 5 is a diagram showing a configuration example of a diagnostic data cloud;

FIG. 6 is a diagram showing a processing flow of a distributed system according to a first solution;

FIG. 7 is a diagram showing an example of a diagnostic model definition screen;

FIG. 8 is a diagram showing a processing flow of a distributed system according to a second solution;

FIG. 9 is a diagram showing an example of a cause analysis result screen for a dealer or a repair company;

FIG. 10 is a diagram showing a processing flow of a distributed system according to a third solution; and

FIG. 11 is a diagram showing an example of a cause analysis result screen for a rental company or a MaaS (Mobility as a Service) company.

### DESCRIPTION OF EMBODIMENTS

In the following embodiments, when necessary for convenience, the description will be divided into a plurality of sections or embodiments, but unless otherwise specified, they are not unrelated to each other, and one is related to a part or all of the other modifications, details, supplementary explanations, and the like.

In addition, in the following embodiments, when referring to the number of elements (including the number, numerical value, quantity, range, and the like), except when explicitly stated and when the number is clearly limited to a specific number in principle, the number is not limited to the specific number and may be more than or less than the specific number.

Furthermore, in the following embodiments, it is needless to say that the components (including the element step and the like) are not necessarily essential except when explicitly stated or when the components are clearly considered to be essential in principle.

Similarly, in the following embodiments, when referring to the shape, positional relationship, and the like of a component or the like, it shall include those that are substantially close to or similar to the shape, or the like, except when explicitly stated or when it is clearly considered that it is not the case in principle. This also applies to the above numerical values and ranges.

Further, in all the drawings for illustrating the embodiments, the same members are in principle denoted with the same reference numerals and the repeated description thereof will be omitted. Hereinafter, each embodiment of the present invention will be described with reference to the drawings.

The present embodiments will be described below. In the following, for the sake of simplification of the description, the form using a cloud server (sometimes simply referred to as a cloud) will be described, but a computer may be used instead of the cloud server. Further, the description of the form using a computer may be applied to the cloud. The cloud server is composed of at least one or more computers.

<System Configuration>

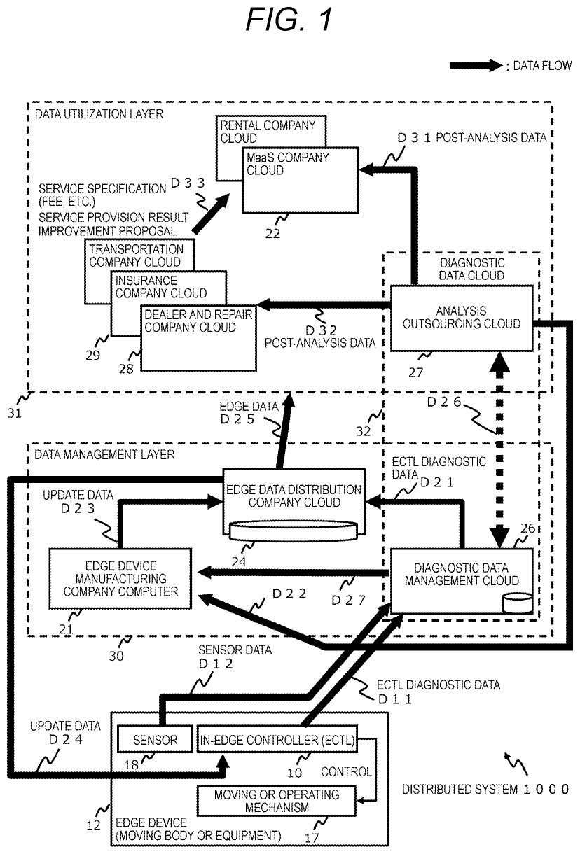

FIG. 1 is a diagram showing a configuration example of an outline of a distributed system. A distributed system 1000 is multi-layered and includes one or more edge devices 12, one or more clouds or computers included in a data management layer 30, and one or more clouds or computers included in a data utilization layer 31.

The edge device 12 may be considered as, for example, a moving body (for example, a vehicle, a drone, or a robot) or equipment (for example, a robot arm, a machine tool, a numerically controlled lathe, or the like) that is capable of automatic operation. In addition, automatic driving is an example of the “automatic operation”.

The edge device 12 includes a moving mechanism (in the case of a moving body, for example, an engine or a motor) or an operating mechanism (in the case of equipment, an actuator such as a motor or hydraulic pressure) 17 and an in-edge controller (for example, an ECU: Electronic Control Unit) 10 that controls the moving mechanism or the operating mechanism 17, and a sensor (for example, GPS: Global Positioning System) 18. Other specific examples of these components will be described later. In addition, “operation” means at least “the device changes its state according to the command in which it is operated, by performing a certain operation (JIS B 0132 compliant).” In the following description, as a simplification of the description, the case where the edge device is a moving body will be described as a representative. Therefore, in the description of the moving mechanism or the operating mechanism 17, the case of the moving mechanism will be described as a representative.

The in-edge controller 10 may be abbreviated as ECTL (Edge ConTroLer). Further, the in-edge controller 10 is in charge of at least apart of the processing for realizing the automatic operation of the edge device 12. Therefore, the in-edge controller 10 is becoming more complicated from the viewpoint of hardware or software. For example, as an example of hardware complexity, GPU (Graphics Processing Unit) and FPGA (Field-Programmable Gate Array), a processor dedicated to neural networks, and other hardware that accelerates machine learning may be included to introduce machine learning processing and processing to recognize and determine data input from various sensors and cameras in real-time.

<<Data Management Layer>>

The data management layer 30 is a virtual layer or group introduced for easy explanation. The cloud included in the layer includes a cloud that stores data generated by the edge device 12 rather than the data utilization layer 31 described later.

A cloud that does not conform to the above description may be included in the data management layer 30, and a cloud that conforms to the above description may be excluded from the layer. In FIG. 1, the following is shown as an example of a cloud or a computer included in the layer (hereinafter, these may be referred to as a data management layer cloud).

Edge data distribution company cloud 24: The cloud stores data related to the edge device 12 (hereinafter referred to as edge data), and transmits unprocessed or processed edge data to the cloud in response to a request from another cloud. As an example of the edge data, in addition to sensor data D12 of the sensor 18 of the edge device 12, the configuration information of the edge device 12 and the like can be considered. In addition, examples of data processing of the present embodiment include change of data representation format, calculation of difference value, calculation of statistical value, encryption, decryption, compression, uncompression, removal of unnecessary data, addition and removal of redundant code, and data extraction. However, if the data received by the processing entity is partially or completely changed and transmitted, it may be regarded as processing. In this specification, the data after the processing may be simply referred to as “processed data”.

Diagnostic data management cloud 26: The cloud indicates the internal state of the in-edge controller 10, stores diagnostic data for diagnosing from outside the controller (hereinafter, may be referred to as in-edge controller diagnostic data or ECTL diagnostic data), and transmits unprocessed or processed edge data in response to a request from another cloud. The ECTL diagnostic data is an example of edge data.

An edge device manufacturing company computer (hereinafter, may be referred to as an edge device manufacturing company computer or a manufacturing company computer) 21: The computer is a computer owned by a company that designs or manufactures the edge device 12. Since the manufacturing company stores edge data for the development and maintenance of its own products, it is included in the data management layer for convenience in this embodiment.

The above are the clouds included in the data management layer 30. From one viewpoint, a company that owns a cloud or a computer of the data management layer 30 (hereinafter, may be simply referred to as a company included in the data management layer) may be considered as a company that designs or manufactures the edge device (including the device per se or components) or a company in charge of distributing edge data. From this viewpoint, the cloud of a telecommunications company, a company that provides a car navigation program executed by a smartphone, and a manufacturing company of a moving mechanism may be considered to be included in the data management layer.

<<Data Utilization Layer>>

The data utilization layer 31 is a virtual layer or group introduced for easy explanation. The layer includes a plurality of clouds or computers (hereinafter, may be referred to as a data utilization layer cloud or a service provider computer). The data utilization layer cloud includes the cloud of the company that is responsible for the part closer to the service provision than the data management layer cloud.

Here, a service suitable as a service provided in the data utilization layer cloud is an edge device related service that uses the edge device 12, or targets an entity related to the edge device 12, or targets the edge device 12 per se. An example of an entity is a group of humans (including a group of humans such as humans and companies), animals, devices (for example, traffic lights, ships carrying edge devices 12, and other devices supporting the automatic operation of the edge device 12 on the outside of the edge device 12). From another viewpoint, a company that owns a cloud included in the data utilization layer (hereinafter, may be simply referred to as a company or a service provider included in the data utilization layer) may be considered as a company that does not design or manufacture the edge device 12 per se or its components (a company that does not have design data 13). In FIG. 1, the following is shown as an example of the data utilization layer cloud.

Transportation company cloud: The cloud is a cloud of a company that directly uses the edge device 12 or operates a transportation business using the services of another transportation company. The process performed in the cloud is a process for receiving the post-analysis data provided from the edge data or an analysis outsourcing cloud 27 and providing the transportation service. An example of such a process is vehicle allocation planning for edge devices, calculation of fares, and an analysis process for revision of service specifications including fares. In this specification, the data after the analysis process may be simply referred to as “post-analysis data”.

Insurance company cloud 29: The insurance company takes on a predetermined risk related to the business of a company that exerts a predetermined function by using the edge device 12. The insurance company performs some or all processes in the insurance company cloud 29 for determining the insurance premium rate with reference to the edge data or the post-analysis data by the analysis outsourcing cloud 27. The risk undertaken by the insurance company may be a risk related to an entity that uses the edge device 12. For example, it is automobile insurance contracted by an individual.

Dealer or repair company cloud 28: The dealer or repair company arranges repairs and maintenance of the edge device 12, and repairs the edge device 12. To support such operations, the cloud receives edge data or post-analysis data provided by the analysis outsourcing cloud 27, generates the information required for maintenance services (prevention and refurbishment) or repair services (accident response), and displays the information to the arranger or repairer.

Rental company or MaaS company cloud 22: What these companies have in common is that they are companies that directly use the edge device 12 or provide transportation services using the services of other passenger transportation companies. In order to support such a service, the rental company or MaaS company cloud 22 receives the post-analysis data provided from the edge data or the analysis outsourcing cloud 27 and generates the information necessary for the maintenance planning of the owned vehicles and the like. The information is displayed to the company's employees and users of the company.

Analysis outsourcing cloud 27: The analysis outsourcing cloud 27 is a cloud that serves as an outsourcing destination for data analysis (hereinafter, may be referred to as a service-related analysis process) necessary for providing or improving services of companies included in the data utilization layer 31. In this embodiment, the case of being in charge of outsourcing the analysis of edge data (particularly ECTL diagnostic data) is described, but this cloud may be in charge of analysis outsourcing of a cloud or company included in the data management layer 30, such as an edge device manufacturing company. In each solution described later, the service-related analysis process is a cause analysis process related to the internal state of the edge device 12 or the in-edge controller 10.

Further, the method of dividing the data management layer 30 and the data utilization layer 31 may be other than these and may not be exclusive. For example, a telecommunications company corresponds to the edge data distribution company cloud 24 and is included in the data management layer 30 from the viewpoint of being related to edge data distribution in the above definition, but is also considered to be included in the data utilization layer 31 from the viewpoint of providing “communication services” to the edge device 12.

<<Advantages of Utilizing Diagnostic Data of In-Edge Controller and Data Flow>>

The feature of the distributed system 1000 in the present embodiment is to utilize diagnostic data that shows the internal state of the in-edge controller 10 (for example, an abnormal state (hereinafter, may be simply referred to as an “abnormality”)) outside the edge device 12, thereby dealing with the distributed system as a whole (including various considerations such as prevention, maintenance, recovery, and improvement). The motive is as explained below.

It is conceivable that the in-edge controller 10 in the future will be complicated in order to realize a moving body capable of automatic operation. In this case, the in-edge controller 10 will take various kinds of internal states. The resolution of these internal states (particularly abnormal states) is not limited to the kind of internal state that can be recovered only inside the edge device 12. Therefore, the applicants considered dealing with various internal states of the distributed system 1000 as a whole by utilizing the diagnostic data showing the internal state of the in-edge controller 10 outside the edge device 12.

The data flow will be explained later but the distributed system 1000 produces the following advantages more specifically.

In the case of an edge device manufacturing company: Since the edge device 12 is complicated due to the automatic operation, the company may have a very high load of state analysis of the edge device 12. By applying the distributed system 1000, it is possible to reduce the load of internal state analysis of the in-edge controller 10 by the manufacturing company of the edge device 12. In particular, this effect becomes more remarkable when the same company as the manufacturing company of the in-edge controller 10 or a related company has the diagnostic data management cloud 26 or the analysis outsourcing cloud 27. This is because cause analysis becomes possible with more detailed knowledge.

In the case of an insurance company: The frequency and tendency of failures for each type of edge device 12 can be used to improve insurance premium rates and insurance payout conditions.

In the case of a transportation company, a rental company, or a MaaS company: It is possible to reduce the deterioration of service provision quality due to an abnormality of the in-edge controller 10. For example, the edge device 12 can be operated efficiently by matching the type of the edge device 12 (or the in-edge controller 10) with the usage environment of the edge device 12 so that the in-edge controller 10 does not cause an abnormality. For example, it is assumed that analysis reveals that a certain type of edge device 12 is inexpensive or can move at high speed, but an abnormality of the edge device 12 (or the in-edge controller 10) is likely to occur in a specific usage environment. Then, it is conceivable to change the usage plan of the edge device 12 so that the usage environment of the edge device 12 of the type can be used in a very different environment from the specific usage environment.

In the case of a dealer or a repair company: When an abnormality occurs, the user can quickly replace the edge device 12, investigate the cause, repair the product, and quickly identify the replacement location.

In the case of the government: In the event of an accident, analysis including ECTL diagnostic data will be possible.

In the case of an analysis outsourcing company: If a predetermined analysis service is already provided before receiving the ECTL diagnostic data, the data to be analyzed will be expanded and, thus, a wider range or more accurate analysis can be provided as a service.

<<<Simple Data Flow to Data Utilization Layer>>>

The simple data flow for enjoying the above advantages starts from the edge device 12 transmitting the ECTL diagnostic data to the outside as shown by ECTL diagnostic data D11. As an example, FIG. 1 illustrates a case where a data management layer cloud, particularly a diagnostic data management cloud 26, receives the ECTL diagnostic data and stores the ECTL diagnostic data in a storage resource. After that, if the cloud that has received the ECTL diagnostic data transmits the ECTL diagnostic data to the cloud of each company, each company can utilize the ECTL diagnostic data.

The data may be processed in the diagnostic data management cloud 26 and the processed data may be transmitted to the cloud of each company.

All or part of the processing of ECTL diagnostic data or the process of data transmission to other clouds by the above-mentioned diagnostic data management cloud 26 may be offloaded to the edge data distribution company cloud 24. In this case, as shown by the data D21, the diagnostic data management cloud 26 transmits the ECTL diagnostic data per se or the processed ECTL diagnostic data in the range handled by the diagnostic data management cloud 26 to the edge data distribution company cloud 24.

The example of processing is already explained but, further, anonymization of personal information and simplification and abstraction of ECTL diagnostic data can be considered.

When the edge data distribution company cloud 24 aggregates the edge data and then provides the edge data to the cloud of the data utilization layer 31, for example, if the edge data distribution company cloud 24 is in charge of distributing the ECTL diagnostic data, the following advantages will be generated.

Since the cloud resources (described later) already possessed by the edge data distribution company cloud 24 of the data utilization layer 31 can be utilized, the cloud resources of the diagnostic data management cloud 26 can be reduced.

Further, the cloud included in the data utilization layer 31 can obtain both the sensor data of the edge device 12 and the ECTL diagnostic data by receiving the data from the edge data distribution company cloud 24.

The ECTL diagnostic data may be received from the edge device 12 by another cloud included in the data management layer 30. Further, the ECTL diagnostic data may be received from the edge device 12 by the cloud included in the data utilization layer 31.

<<<Data Flow When Strengthening Diagnostic Data Management Cloud>>>

Suppose that the processing of the diagnostic data management cloud 26 is repeatedly strengthened so that the enhanced data after the processing can be transmitted to another device. However, such processed data cannot be transmitted to the data utilization layer cloud unless the program is modified so that the processed data can be received by the edge data distribution company cloud 24 side, stored in the storage resource, and transmitted to the data utilization layer cloud. In order to avoid such a situation, the diagnostic data management cloud 26 may transmit the processed data to the data utilization layer cloud without going through the edge data distribution company cloud 24. In order to realize the transmission, for example, the following method or configuration can be considered.

(Cooperation) An analysis outsourcing company that has an analysis outsourcing cloud 27 concludes a contract with a company that has a diagnostic data management cloud 26, and acquires interface specifications and usage rights to receive formatted data. The analysis outsourcing company can obtain the processed data for which the usage right has been obtained by modifying the program of the analysis outsourcing cloud 27 of its own company according to the interface specifications. The data D26 of FIG. 1 (hereinafter, may be referred to as cooperation data or cooperation data in the diagnostic data cloud) indicates the enhanced data after performing the processing (processed data).

The interface specifications and usage rights may be obtained other than the contract. For example, the analysis outsourcing cloud 27 and the diagnostic data management cloud 26 may be operated by the same company or a company having a capital relationship to secure interface specifications and usage rights.

(Integration) The diagnostic data management cloud 26 also serves as the analysis outsourcing cloud 27. In the integration, the computers that realize both clouds may be placed in the same data center, or the programs and data to be executed in both clouds may be placed together in a common computer. Alternatively, at least one of the plurality of virtual computers assigned to the same computer may be used for the diagnostic data management cloud 26, and the other at least one may be used for the analysis outsourcing cloud 27. From another viewpoint, “the diagnostic data management cloud 26 also serves as the analysis outsourcing cloud 27” may be considered to mean that resources of a certain data center (for example, a processor, a storage resource, a communication device, a network, and a management software for managing the resources, which will be described later) are shared on both clouds.

The above is an example of cooperation and integration. When such cooperation or integration is performed, the analysis outsourcing cloud 27 can provide the data utilization layer cloud with the processed data that is not transmitted from the edge data distribution company cloud 24 and, thus, a wider range or highly accurate analysis can be provided as a service. Further, since the transmission schedule to the data utilization layer cloud can be arranged by the analysis outsourcing cloud 27 or the diagnostic data management cloud, it is possible to provide the analysis result in real-time. For real-time provision, the transmission schedule may have an interval shorter than, for example, the edge data transmission and reception schedule of the edge data distribution company cloud.

In the following description, the aggregate of the diagnostic data management cloud 26 and the analysis outsourcing cloud 27 may be referred to as a diagnostic data cloud 32. The diagnostic data management cloud 26, which also serves as the analysis outsourcing cloud 27, is also included in the diagnostic data cloud 32.

<<Additional Roles of Diagnostic Data Management Cloud and Analysis Outsourcing Cloud>>

The diagnostic data management cloud 26 and the analysis outsourcing cloud 27 may perform roles or processes other than those described above. For example, when the diagnostic data management cloud 26 is operated by the design or manufacturing company of the in-edge controller 10, it is also possible to manage the design or manufacturing of the in-edge controller 10 in the diagnostic data management cloud 26. Further, the ECTL diagnostic data stored in the diagnostic data management cloud 26 may be analyzed to improve the in-edge controller 10.

Furthermore, the analysis outsourcing cloud 27 may be a company that designs or manufactures the edge device 12 per se or its components. In this case, it becomes easy to prevent the design knowledge and manufacturing knowledge of the in-edge controller 10 from being unnecessarily diffused to other companies included in the data utilization layer 31 excluding the analysis outsourcing cloud 27.

<<Data Flow Between Clouds>>

Although some have already been explained, the distributed system 1000 shown in FIG. 1 has the following data flow. The cloud or computer where the arrow in the drawing is starting to appear is the entity that transmits data, and the cloud or computer to which the arrow is pointed is the entity that receives the data. Regarding the data flows D11 to D33, if the flow is desired to be emphasized, it is expressed as “arrow” D11 to D33, and if the content of the flowing data is paid attention to, it is expressed as “data” D11 to D33. When a plurality of contents of “data” D11 to D33 are listed, it does not necessarily mean that the listed contents are transmitted at the same time. The transmission timing may be different and transmission of some contents may be omitted.

Data flow (or data) D11: ECTL diagnostic data.

Data flow (or data) D12: Sensor data. Although not shown, the sensor data may be received by the in-edge controller 10.

Data flow (or data) D21, D27: ECTL diagnostic data. In the flow of this data, the processed ECTL diagnostic data may flow.

Data flow (or data) D22: Data after cause analysis process, or improved data for the edge device based on cause analysis results. Improved data includes, for example, improved controller design data, programs, diagnostic sequences, or thermal design data. The diagnostic data management cloud 26 may be the transmission source of a part of the data D22.

Data flow (or data) D23: Data related to the specifications, manuals, and configurations of the edge device 12. Further, a program executed by the edge device 12 (for example, a program for a car navigation system, a voice recognition program, a program for the in-edge controller 10, and the like) and parameters referred to by the program. The data D23 may include the program per se executed by the edge device 12 and the parameter per se.

Data flow (or data) D24: Same as the data transmitted as data flow D23. The data per se transmitted as D23 may be used or processed (for example, after encryption or compression) data may be used. The data flow D24 may be received by a component other than the edge device 12 per se or the in-edge controller of the edge device 12.

Data flow (or data) D25: Edge data. The edge data described so far mainly describes data whose value changes dynamically. However, static data such as specifications and manuals of the edge device 12 are also data related to the edge device 12 and may be included in the edge data. This edge data is transmitted from the edge data distribution company cloud 24 to the cloud of the data utilization layer 31. The data may be transmitted from the edge data distribution company cloud 24 to the cloud of the data management layer 30.

Data flow (or data) D26: Cooperation data in the diagnostic data cloud.

Data flow (or data) D31, D32: Post-analysis data. As a result of the analysis process performed by the analysis outsourcing cloud 27, for example, repair information such as the failure location and the linking of the device to be replaced, and maintenance information related to the edge device 12 such as the degree of deterioration of each edge device 12 and the maintenance deadline are included. This data is data used for service provision or improvement of a company included in the data utilization layer 31.

Data flow (or data) D33: Service-related data. This is data transmitted from the cloud or computer of the data utilization layer 31 that provides the service to the cloud or computer of another company of the same data utilization layer 31. For example, there are service specifications (insurance premium rates, fares, various charges, and the like may be included), service provision results, and improvement proposals for service specifications.

<<Description of Other Clouds>>

Although it has been partially explained, it is as follows. Edge data distribution company cloud: A cloud that distributes the above-mentioned edge data D25 to the data utilization layer cloud. In addition, the cloud may distribute the post-analysis data generated by the analysis process in any cloud. Further, the edge data distribution company cloud 24 transmits the above-mentioned data D24. The edge data distribution company cloud 24 may be considered as a common platform for communicating with clouds owned by an edge device manufacturing company (multiple companies are possible), a diagnostic data management cloud company (multiple companies are possible), and a company included in the data utilization layer (multiple companies are possible). In such a case, in order to transmit and receive data, it may have more cloud resources (mainly communication bandwidth and arithmetic processing capacity) as compared with other companies.

Furthermore, in order to avoid a situation that becomes a bottleneck of cloud resources when transmitting and receiving data to and from a large number of edge devices 12 existing in addition to the clouds or computers of many companies, the edge data distribution company cloud 24 may transmit and receive data based on the schedule determined in advance.

<Edge Device>

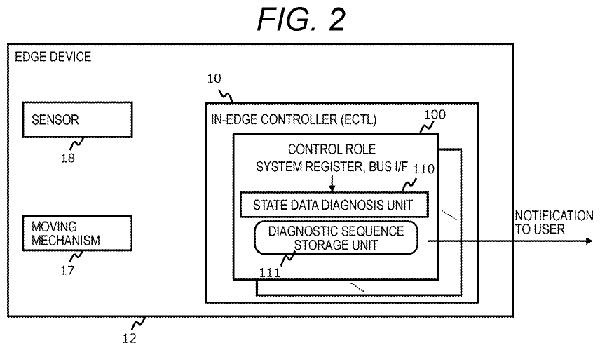

FIG. 2 is a diagram showing an outline of a configuration example of an edge device. The edge device 12 includes the following configuration (the items already explained have been omitted).

Moving mechanism or operating mechanism 17: The moving mechanism will be described as a representative. Examples of the moving mechanism 17 include a force transmission structure such as a wheel, a shaft, a belt, and a gear, an actuator such as a motor and a hydraulic pressure, a component that generates or suppresses a force such as a brake and a motor. However, another mechanism may be used.

In-edge controller 10 that controls the moving mechanism 17 of the edge device 12: Examples of the controller include an ECU of a vehicle, a controller of a drone, a PLC in the industrial field, and an NC controller of a machine tool. The edge device 12 may include a plurality of in-edge controllers 10.

When the edge device 12 is a vehicle and the in-edge controller 10 is an ECU, the edge device 12 may include a plurality of in-edge controllers 10, and each in-edge controllers 10 may have a different control role (lane keeping, inter-vehicle distance control, engine speed control, and communication control with the outside of the edge device 12). The common in-edge controller 10 may have a plurality of control roles. In the automobile industry, such a control role is sometimes called a “function” or a “system function”. Further, such a method of having a control role may be applied when the in-edge controller 10 is other than the ECU.

The hardware constituting the in-edge controller 10 is, for example, a central processing unit (CPU), a GPU, an application specific integrated circuit (ASIC) for data processing, a bus, and a sensor, but not all of them are required. The logical configuration of the in-edge controller 10 will be described with reference to FIG. 2. The in-edge controller 10 has one or more control roles and each control role includes a state data diagnosis unit 110 and a control processing unit (not shown).

The control processing unit of the in-edge controller 10 performs the control processing necessary to realize the control role. The control processing unit is the hardware that constitutes the in-edge controller, and is realized by executing a program (hereinafter, may be referred to as a control program). The control program may be installed or updated, or update the parameters thereof by the data D24 (update data) received by the in-edge controller 10. As an example, when the control role is speed maintenance, the control program is a program that compares the speed (one of the sensor data) measured by the speedometer, which is one of the sensors 18, with the designated speed and executes the process of transmitting the engine throttle opening or closing instructions and acceleration or deceleration instructions to the motor.

The state data diagnosis unit 110 acquires information indicating the state of the hardware constituting the edge device (one of the internal states of the in-edge controller 10) according to the diagnostic sequence stored in a diagnostic sequence storage unit 111 and generates data D11 (ECTL diagnostic data). Further, the state data diagnosis unit 110 may acquire information indicating the state of the control processing unit by monitoring the control processing unit (more specifically, the control program) and handle the information in the same way as the information indicating the state of the hardware constituting the above-mentioned in-edge controller.

The diagnostic sequence is definition information for acquiring information indicating the above state in the order specified from the outside by the state data diagnosis unit 110. The more specific content of the diagnostic sequence will be shown later.

The edge device 12 may also have a sensor 18 for measuring the state of the edge device 12 as a component thereof. As examples of the sensor 18, devices such as a GPS, a fuel system, a speedometer, a rotation meter (for motors, engines, and wheels), a range finder (for example, a range finder using LiDAR (Light Detection And Ranging) or ultrasonic waves), position or displacement sensors, and angle detection sensors are conceivable. The data generated by these sensors 18 and the in-edge controller 10 (hereinafter, may be referred to as edge-generated data) is transmitted to the cloud of the data management layer 30 (diagnostic data management cloud 26) or the in-edge controller 10. Communication from the edge device 12 to the outside is typically realized by a wireless communication module (for example, a Wi-Fi (registered trademark) module or a 5G communication module), but the wireless communication module does not necessarily have all the components of the edge device 12. Alternatively, the edge device 12 may include a gateway device (for example, an ECU, a smartphone, a wireless router) having a wireless communication module and the gateway device may consolidate communication processing with the outside.

The edge device 12 is not limited to devices manufactured by the same company but includes devices of various generations and types. Furthermore, the edge device is not limited to either a moving body or equipment and may be ones that serve as both.

<Hardware Configuration of Cloud or Computer>

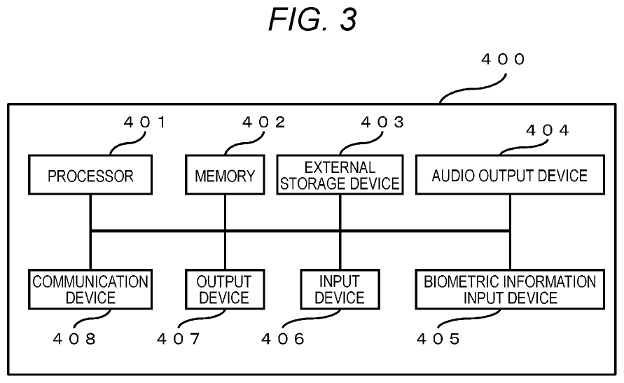

FIG. 3 is a diagram showing an example of the hardware configuration of a computer 400 constituting each cloud. Since the computer is one of the devices, it may be called a computer device.

The computer 400 is configured to include a processor 401 such as a CPU, a memory 402 as a main storage device, an external storage device 403 such as a hard disk or a solid state drive (SSD), an audio output device 404 such as a speaker, a biometric information input device 405 such as a camera, a line-of-sight input device, and a microphone, an input device 406 such as a keyboard, a mouse, and a touch panel, an output device 407 such as a display and a printer, a communication device 408 such as a network interface card (NIC), and a bus connecting these. Not all of these components are essential.

The memory 402 is, for example, a memory such as a random access memory (RAM).

The external storage device 403 is a non-volatile storage device such as a so-called hard disk, SSD, or flash memory that can store digital information.

The communication device 408 is a wired communication device that performs wired communication via a network cable, or a wireless communication device that performs wireless communication via an antenna. The communication device 408 communicates with other devices connected to the same network. For the communication, packet communication by TCP/IP (Transmission Control Protocol/Internet Protocol) is adopted, but the communication is not limited thereto and communication by other protocols such as UDP (User Datagram Protocol) may be adopted.

Further, a communication unit (not shown) that is communicably connected to a local area network (LAN) or the like is realized by the communication device 408.

The above is an example of the computer 400 hardware configuration that constitutes each cloud in the present embodiment. However, the configuration of the computer 400 is not limited thereto and may be configured by using other hardware. Further, the computer 400 may be various information processing devices such as a server computer, a personal computer, a notebook personal computer, a tablet device, a smartphone, and a television device.

Although not shown, the computer 400 may have a known program such as an operating system (OS), middleware, or an application. Such a program is executed by the processor 401 in the same manner as other programs, so that the computer 400 performs a predetermined process. In addition, the components described by the names of “units” in each cloud of the present specification may be realized by the above-mentioned programs, except for those clearly stated to be areas of storage resources. Further, the processor 401 is not limited to the CPU and may be realized by other processors such as GPU and FPGA.

In addition, since the functional boundaries between the memory 402 and the external storage device 403 have become ambiguous due to technologies such as virtualization, it is not necessary to make a strict distinction as long as they can be used as storage resources. Furthermore, the concept of including the processor, the storage resource, and the communication device 408 may be referred to as a cloud resource. It is also possible to consider the cloud as the entire data center. In this case, the cloud resources may include network switches, routers, data center power supplies, and cooling equipment as part of the cloud resources. Further, the computer 400 may be a virtual entity such as a virtual machine that virtualizes the hardware of the physical computer 400.

In a computer for server use such as the Web, an input device and an output device may be omitted. In this case, those devices are replaced by the computer for server use receiving the input of the input device provided in another computer for client use (client computer) connected to the server computer as input data, using the communication device 408. Similarly, the computer for server use transmits the data to be output to the client computer using the communication device 408 and outputs the output data to the output device of the client computer. Regardless of the presence or absence of the input device and the output device, the common point is that the input data is received and the output process is performed by the program executed by the computer for server use. In a Web application using HTML (HyperText Markup Language) and JavaScript, text to be displayed on the output device is generated by executing HTML or JavaScript on a client computer that executes a Web browser. In this case, the “output processing” includes the transmission processing of HTML data and JavaScript data by the Web server program executed by the computer for the Web server.

The above is an example of the hardware configuration of the computers that constitute the cloud. The diagnostic data management cloud, the edge device manufacturing company computer 21, and the edge data distribution company cloud 24, which are clouds belonging to the data management layer 30, and the rental company or MaaS company cloud 22, the transportation company cloud, the insurance company cloud 29, the dealer or repair company cloud 28, and the analysis outsourcing cloud, which are clouds belonging to the data utilization layer 31, have the same hardware configuration as the computer 400.

<Computer Configuration of Edge Device Manufacturing Company>

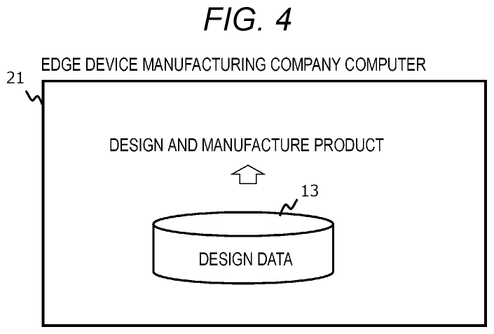

FIG. 4 is a diagram showing an outline of a configuration example of an edge device manufacturing company computer. The edge device manufacturing company computer (manufacturing company computer) 21 stores at least the design data 13 in the storage resource. The edge device manufacturing company computer 21 reads and processes the design data 13 in the product design and manufacturing processes. Therefore, although not shown, the manufacturing company computer 21 may execute a program that supports the design or manufacturing of the edge device 12, such as a CAD (Computer-Aided Design) program, a CAE (Computer Aided Engineering) program, and a manufacturing management program.

<Configuration of Diagnostic Data Management Cloud>

Before explaining the solution for each service provision format, the logical configuration of the common diagnostic data management cloud will be described. The diagnostic data management cloud 26 uses the above-mentioned computer 400 to receive the data D11 (ETCL diagnostic data) from the in-edge controller 10, the data D12 (sensor data) from the sensor 18, and the data D26 described in FIG. 1 and the like. Similarly, the diagnostic data management cloud 26 transmits the data D21, the data D26, and the data D27 described in FIG. 1 and the like. These transmission and reception processes are performed by executing a program stored in the storage resources of the computer 400 constituting the diagnostic data management cloud 26 (hereinafter, may be referred to as a diagnostic data management program) by the processor.

Further, the diagnostic data management program stores the data D11 (ECTL diagnostic data) and the data D12 (sensor data) in the storage resource, and, thus, these data can be transmitted to each cloud at an appropriate timing. The diagnostic data management program may transmit or receive these data based on a predetermined schedule or on-demand.

<Analysis Outsourcing Cloud Configuration>

Before explaining the solution for each service provision format, the logical configuration of the common diagnostic data management cloud will be described. The analysis outsourcing cloud 27 uses the above-mentioned computer 400 to receive the data D25 (edge data) and the data D26 described in FIG. 1 and the like. Similarly, the analysis outsourcing cloud 27 transmits the data D31 and D32 (post-analysis data), the data D22, and the data D26 described in FIG. 1 and the like. These transmission and reception processes are performed by executing a program stored in the storage resources of the computer 400 constituting the analysis outsourcing cloud 27 (hereinafter, may be referred to as an analysis outsourcing program) by the processor. Further, the analysis outsourcing program stores the received data D25 (edge data) and D26 in the storage resource to prepare for the analysis process.

The purpose of the analysis process by the analysis outsourcing program is as described above (or will be described later), but in order to realize the purpose, for example, the following processes may be performed.
Reception and storage process of data required for analysis from the outsourcing source cloud (hereinafter referred to as analysis prerequisite data). Here, the analysis prerequisite data is received via the communication device. In addition, the received analysis prerequisite data is stored in the storage resource.
Understanding the tendency of abnormality occurrence by a statistical process or a machine learning process (for example, SVM (Support Vector Machine) or neural network). As the data used for the process, analysis prerequisite data may be used in addition to the data D25 (edge data) and D26.
Analysis process of abnormality cause or range of influence. Based on the configuration information of the edge device 12 and the causal relationship information of the abnormal state (an example is the analysis rule of a first solution to be described later), the component that caused the predetermined abnormality and the component affected by the predetermined abnormality are identified (or candidates are identified). The above-mentioned configuration information and relationship information may further include the configuration information and relationship information inside the component of the edge device 12. Further, configuration information and relationship information outside the edge device 12 (for example, a device that supports the automatic operation of the edge device 12 described above) may be considered. As the data used for the process, analysis prerequisite data may be used in addition to the data D25 (edge data) and D26.
FTA (Fault Tree Analysis) analysis process.

As shown in FIG. 1, a common analysis outsourcing program may transmit data D32 and data D31 (post-analysis data) to a plurality of different types of service providers, and a customized analysis outsourcing program for a specific service may be prepared. Further, if there is a common analysis even for a plurality of services, the post-analysis data generated in the analysis process of the first service or the intermediate data during the analysis process may be used in the analysis process of a second service. Here, the first and second services may be the same type of service or different types of services.

The solutions for each company will be described below but the described technique can be applied to solutions for other companies.

<First Solution (for Edge Device Manufacturing Companies)>

The distributed system 1000 can provide the ECTL diagnostic data and the analysis result to the edge device manufacturing company according to the data flow D22, and the solution will be described below with an example. This example is merely an example of a mode in which the distributed system 1000 according to the present invention is used, and does not limit the applicable range of the present invention. In this specification, when the edge device 12 is an automobile, the edge device manufacturing company may be referred to as an OEM (Original Equipment Manufacture) specified in ISO 16949. The solution includes the manufacturing company computer 21 owned by an edge device manufacturing company, but the computer will be omitted as the computer has already been explained.

<<In-Edge Controller>>

The in-edge controller 10 includes a diagnostic circuit in addition to the configuration as described above. The diagnostic circuit is a circuit for diagnosing the hardware component of the in-edge controller 10. The diagnostic circuit includes an in-edge controller sensor for diagnosing a component, and an IF circuit that provides the value obtained by the sensor as it is or after processing to the state data diagnosis unit 110. Here, examples of the in-edge controller sensor include a thermometer, an ammeter, and an ohmmeter attached to the component of the in-edge controller 10. Since the FPGA can be regarded as having a logical circuit inside, the FPGA may be used as one of the means for realizing the diagnostic circuit.

The state data diagnosis unit 110 targets information indicating the electronic state (for example, the value stored by the system register and the contents of the bus I/F) of the edge device 12 (particularly the in-edge controller). Here, since the information is in the low-level data notation format provided by the hardware per se, the information is called the state information in the hardware-dependent format. Therefore, the state data diagnosis unit 110 acquires the state information in the hardware-dependent format according to the diagnostic sequence and performs the diagnosis process. The timing of acquiring the state information in the hardware-dependent format may be, for example, triggered by detecting an abnormal state, or periodical (once a day, or the like), or at startup.

The diagnostic sequence information is stored in the diagnostic sequence storage unit 111 included in the in-edge controller 10. Then, when the state data diagnosis unit 110 performs the diagnosis process, the diagnostic sequence is read out and used. Here, since the state information in the hardware-dependent format is too low-level information, it is inconvenient to handle the information in each cloud and it is a waste of storage resources of the in-edge controller 10 to repeatedly acquire all the information and sequentially store the information.

The diagnostic process based on the diagnostic sequence performs the process of narrowing down to the state information related to the abnormal state or the cause candidates, data storage, or data transmission by processing the state information into a hardware-independent data format to eliminate the inconvenience, or narrowing down the cause candidates of the abnormal state occurred. The information included in the data D11 (ECTL diagnostic data) in the present solution can be said to be the state information processed by such a diagnostic process. The hardware-independent data format of the state information is preferably a format defined as a standard interface defined between the plurality of manufacturing companies of the in-edge controller 10 but may be a different format.

For example, the following is defined as a diagnostic sequence that plays the role as described above.
A plurality of diagnostic items.
Diagnosis order between diagnostic items and execution conditions for diagnostic items.
Conditions for starting the diagnostic sequence.

The diagnostic items here include, for example, the following.
Parameter for acquiring state information in a hardware-dependent format. For example, there are a system register address, a memory-mapped area address, and an interrupt number.
Processing parameters for processing state information in a hardware-dependent format into a hardware-independent data format. For example, when the register value is “0xFFFF”, these parameters are managed as a set in order to output “False” text, which is a hardware-independent data format indicating that the hardware is abnormal.

The diagnostic program that realizes the state data diagnosis unit 110 interprets the definition of the diagnostic sequence and performs the process according to the definition.

<<Diagnostic Data Cloud>>

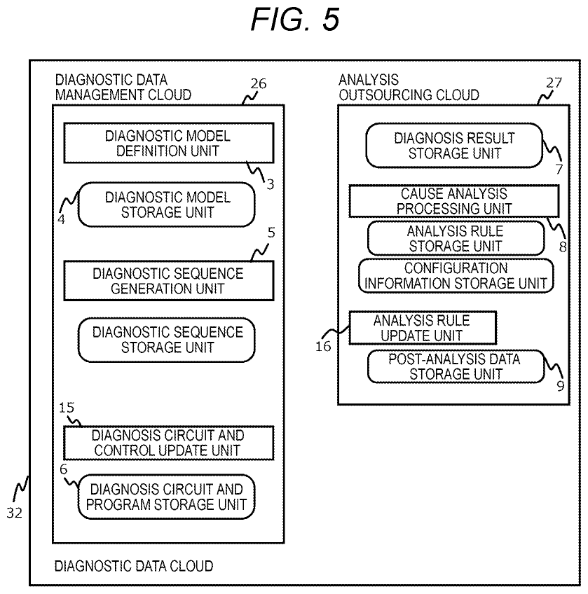

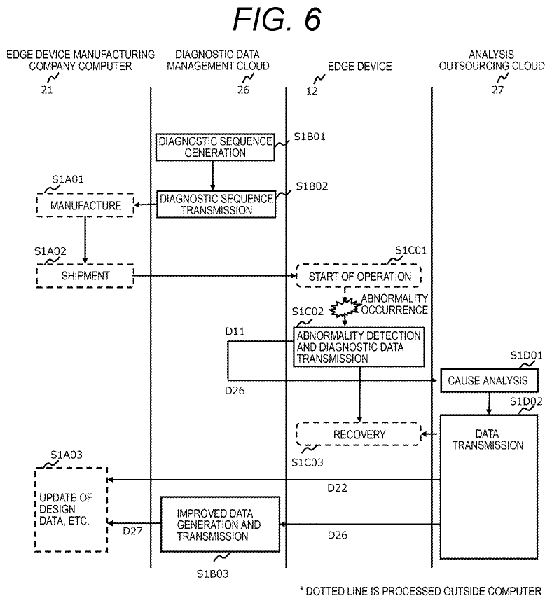

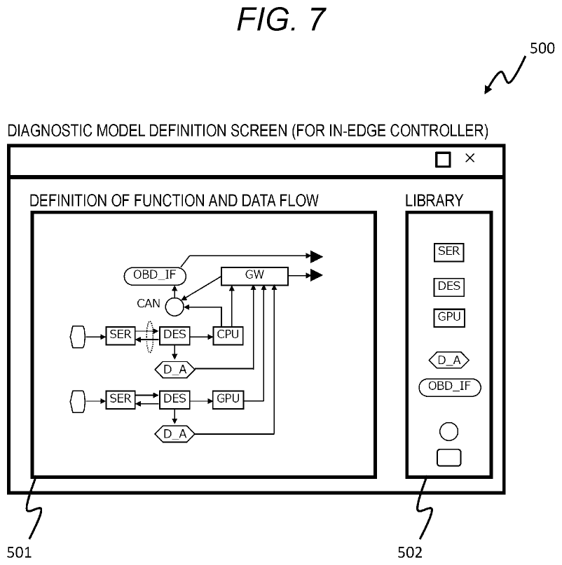

FIG. 5 is a diagram showing a configuration example of a diagnostic data cloud. The diagnostic data cloud 32 includes the diagnostic data management cloud 26 and the analysis outsourcing cloud 27. A partial component of the diagnostic data management cloud 26 described below may be moved as a component of the analysis outsourcing cloud 27. Further, a partial component of the analysis outsourcing cloud 27 described below may be a component of the diagnostic data management cloud 26. In FIG. 5, since each “unit” represented by a square with rounded corners is a unit realized by the storage resource of the cloud, in other words, a part of the storage area provided by the storage resource, the “unit” as described in the above can be read as “area”. Each “unit” represented by a square with no rounded corners is realized by using the program described in the computer 400. The details will be described below. However, in that case, the drawing numbers included in FIGS. 6 to 7 which will be described later may be described.

<<<Diagnostic Data Management Cloud>>>

The diagnostic data management cloud 26 includes a diagnostic model definition unit 3, a diagnostic model storage unit 4, a diagnostic sequence generation unit 5, a diagnostic circuit and program storage unit 6, a diagnostic circuit and control update unit 15, and a diagnostic sequence storage unit.

The diagnostic model definition unit 3 defines a diagnostic model based on the design data 13. Specifically, the diagnostic model definition unit 3 displays a screen to display the product design data 13, illustrates functions including product components and diagnostic points, receives input configuration relationships of diagnostic points, and stores the input configuration relationships in the diagnostic model storage unit 4 as a diagnostic model. The diagnostic model definition unit 3 is mainly used by the owner of the diagnostic data management cloud 26, but is not limited thereto and may be used by an edge device manufacturing company. Here, the above-mentioned “product” is the edge device 12 or a component of the edge device 12, or the in-edge controller.

The diagnostic model is stored in the diagnostic model storage unit 4. The diagnostic model will be described later.

The diagnostic circuit and control update unit 15 receives the post-analysis data analyzed and processed by the analysis outsourcing cloud 27 and updates the diagnostic circuit information (more accurately, diagnostic circuit design information) and the diagnostic program stored in the diagnostic circuit and program storage unit 6. Here, the diagnostic program is a program that realizes the state data diagnosis unit 110 by being duplicated in the in-edge controller 10 and then executed by the in-edge controller 10.

The diagnostic circuit and program storage unit 6 stores diagnostic circuit information or a diagnostic program. The diagnostic circuit and program storage unit 6 may store the interface specifications of the diagnostic circuit and the diagnostic program. Since the diagnostic circuit information is a part of the design data 13, the diagnostic circuit information at the start of the solution may be obtained by extracting the corresponding information from the design data 13 and storing the information in the diagnostic circuit and program storage unit 6, or by storing the diagnostic circuit information possessed by the in-edge controller manufacturing company in the diagnostic circuit and program storage unit 6. The same applies to the diagnostic program.

The diagnostic sequence generation unit 5 generates a diagnostic sequence based on the diagnostic model, the diagnostic circuit information, and the diagnostic program (or the information of the diagnostic program). The generated diagnostic sequence is stored in the diagnostic sequence storage unit and then transmitted to the in-edge controller 10. Therefore, the definition of the diagnostic sequence generated by the diagnostic sequence generation unit is the same as the definition of the diagnostic sequence described in the in-edge controller 10.

<<<<Relationship Among Diagnostic Model, Diagnostic Sequence, and Diagnostic Program>>>>>

Here, the relationship or difference among the diagnostic model, the diagnostic sequence, the diagnostic program, and the diagnostic circuit will be summarized. As described above, the diagnostic sequence, the diagnostic program, and the diagnostic circuit are components of the in-edge controller 10, and updates thereof are repeated by the diagnostic data cloud 32. Therefore, the diagnostic sequence, the diagnostic program, and the diagnostic circuit (information thereof) may be considered as a part of the design data 13. On the other hand, the diagnostic model is regarded as intermediate data for generating a diagnostic sequence from the design data 13. The feature thereof is a data representation that can increase hardware-independency than diagnostic sequences and group (block) a series of frequently used diagnostic items in order to enhance the reusability of the diagnostic model and reduce the creation load. Further, the diagnostic model may be made to be a data representation common to a plurality of types of products so that the reusability of the model can be enhanced.

<<<Analysis Outsourcing Cloud>>>

The analysis outsourcing cloud 27 includes a diagnosis result storage unit 7, a cause analysis process unit 8, a post-analysis data storage unit 9, an analysis rule update unit 16, an analysis rule storage unit, and a configuration information storage unit.

The diagnosis result storage unit 7 stores the ECTL diagnostic data received from the in-edge controller 10 via the diagnostic data management cloud. The data flow may be a series of data flow D11, D21, and D25, or a series of data flow D11 and D26. As described above, the flow using D26 can obtain more real-time data.

The cause analysis process unit 8 identifies the abnormality cause of the component of the product by analyzing the ECTL diagnostic data based on the analysis rule and the configuration information. The unit of the component to be identified may be a unit of a replacement part or a unit of a component that is easy for a person who analyzes the identified abnormality cause to understand. Further, it is desirable that the cause analysis process unit 8 associates the information on the abnormality cause with the information on the abnormality that has occurred. When the information of the edge device 12 is insufficient in the configuration information storage unit, the cause analysis process unit 8 receives the design data 13 from the edge data distribution company cloud 24 or the manufacturing company computer 21 and uses the received design data 13.

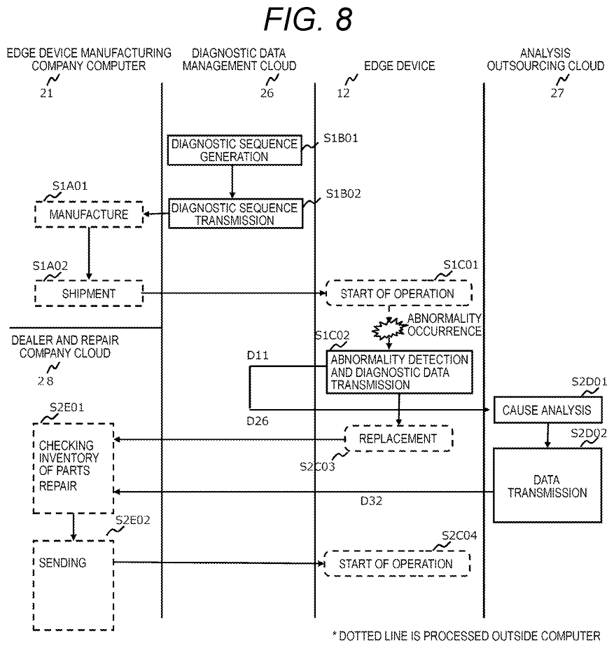

The analysis rule is information that defines the chain relationship of abnormalities, that is, the chain relationship of abnormal states that occur in a chain based on the causal relationship of the abnormality. The analysis rule storage unit stores such analysis rules. The analysis rule may be generated based on the design data 13 or may be generated based on the diagnostic model. Therefore, the analysis rule per se may be generated by the edge device manufacturing company computer 21 or the diagnostic data management cloud 26 and transmitted to the analysis outsourcing cloud 27. Alternatively, the design data 13 and the diagnostic model may be duplicated in the analysis outsourcing cloud to generate analysis rules in the analysis outsourcing cloud. In FIG. 8, which will be described later, one of them will be described as an example.

The configuration information storage unit stores configuration information, which is information indicating the configuration of the product. The configuration may include, for example, static information such as the model number and the serial number of the product component, and values related to the component that dynamically changes with the operation (for example, cumulative fuel consumption) acquired from other than ECTL diagnostic data.

When the abnormal state inside the in-edge controller 10 is identified, the cause may be the in-edge controller 10 or the outside of the in-edge controller 10 (for example, the edge device 12 and other components of the edge device 12). Therefore, preferably, the analysis rule and the configuration information include information not only about the in-edge controller 10 but also about the edge device 12 and other components of the edge device 12.

When the diagnostic sequence (or design data 13) is changed, the analysis rule update unit 16 updates the analysis rule stored in the analysis rule storage unit in accordance with the change. For this purpose, the analysis rule update unit 16 may receive the design data 13 from the diagnostic data management cloud 26 or the manufacturing company computer 21.

<<Diagnostic Model Definition Screen and Diagnostic Model>>

Next, the diagnostic model definition screen and the diagnostic model will be described with reference to FIG. 7.

FIG. 7 is a diagram showing an example of a diagnostic model definition screen. A diagnostic model definition screen 500 is a screen that is created by the diagnostic model definition unit 3, receives input information when defining a diagnostic model, and displays output information that has reflected the input information. Then, the diagnostic model definition unit 3 creates a predetermined diagnostic model based on the definition information input on the diagnostic model definition screen 500 and stores the diagnostic model in the diagnostic model storage unit 4.

On the diagnostic model definition screen 500, a screen for visually and interactively designing product functions based on the design data 13 is displayed. The screen user designs an abstracted diagnostic sequence using this screen.

The diagnostic model definition screen 500 includes a function and data flow definition area 501 and a library area 502.

These areas have the following meanings.
In the library area 502, nodes (referred to as component meta-nodes) indicating components included in the product or component candidates that may be included in the product in the future are arranged for each type. The component meta-node may correspond to one type of component, may correspond to an aggregate of a plurality of types of components, or may correspond to a part of a predetermined type of component.
In the function and data flow definition area, a node indicating the components included in the product (component instance node) and a link object indicating the data flow between the components indicated by the component instance node (indicated by arrows in the drawing) are included.

A plurality of pieces of attribute information can be added to the component meta-node. In addition, a part or all of the attribute information can be acquired and specified from the diagnostic circuit or the diagnostic program. For example, the following can be added as attribute information to the component meta-node that is “GPU”.
Presence or absence of internal memory error
Whether or not a calculation core exception has occurred
Presence or absence of internal bus error

Similar attribute information is also given to the link object. The attribute information of the link object is as follows, for example.
Specified information of which information to transmit to the transmission destination component instance node from the attribute information of the transmission source component instance node in the data flow indicated by the link object.
Information reception frequency

The above is the attribute information of the link object. It is also possible to add attribute information to the component instance node. The attribute information may be, for example, a subset of the attribute information of the corresponding type of component meta-node.

When the screen user desires to create a diagnostic sequence corresponding to a new diagnostic circuit, the screen user performs the following operations.
Create a component meta-node corresponding to a new diagnostic circuit in the library area 502 and add attribute information.
Drag and drop the created component meta-node into the function and data flow definition area 501 to instantiate the meta-node. This creates a component instance node that corresponds to the new diagnostic circuit.
Click the component instance node corresponding to the component that the diagnostic circuit desired to be diagnosed, and then click the created component instance node. This creates a link object meaning that data flows from the diagnostic target component to the diagnostic circuit.
Set the attribute information of the transmission source component instance node desired to be diagnosed by the diagnostic circuit in the attribute information of the created link object.

By performing the save operation after the above operation, the diagnostic model is stored in the diagnostic model storage unit 4. Compared with the diagnostic sequence, the diagnostic circuit, and the diagnostic program, the display information on the diagnostic model definition screen is less hardware-dependent and, therefore, more reusable to different types. In addition, since a plurality of pieces of attribute information are added to one node or link object so that they can be grouped together, diagnostic items can be grouped.

The diagnostic model stores the contents of the function and data flow definition area created on the above-mentioned diagnostic model definition screen 500. Therefore, for example, the following is stored in the diagnostic model.
Component meta-node information. The information includes attribute information.
Component instance node information. The information includes the identifier of the component meta-node specified at the time of generation. In addition, the attribute information may be included in the information.
Link object information. The information includes an identifier of the transmission source component instance object, an identifier of the transmission destination component instance object, and attribute information for flowing data.

Here, for the purpose of reducing the hardware dependence of the diagnostic model definition screen and the diagnostic model, the following may be performed.
The name of the attribute information is made to be a generalized name of the diagnostic item in the diagnostic sequence.
The diagnostic model does not include hardware-dependent information (for example, above-described parameters, and machining parameters) of diagnostic items included in the diagnostic sequence.

<<Flow of Cooperation Among Computers, Clouds, and Edge Devices>>

FIG. 6 is a diagram showing the flow of cooperation among the computer, the cloud, and the edge device in the first solution. Each will be described below.

(Step S1B01) The diagnostic data management cloud 26 (more specifically, the diagnostic model definition unit 3) generates a diagnostic sequence.

(Step S1B02) The diagnostic data management cloud 26 (more specifically, the diagnostic model definition unit 3) transmits the generated diagnostic sequence. In FIG. 6, the edge device manufacturing company computer 21 is described as an example of the transmission destination, but the transmission destination is not limited to this computer or cloud even in this solution.

(Step S1A01) The edge device manufacturing company manufactures the edge device 12. At this time, the diagnostic sequence transmitted in S1B02 is stored in the in-edge controller 10.

(Step S1A02) The edge device manufacturing company ships the manufactured edge device 12. The shipping destination may be an individual in addition to the company or group shown in FIG. 1 and the related description (hereinafter collectively referred to as an edge device using entity). The edge device 12 shipped in this step may be referred to as the current generation edge device.

(Step S1C01) The edge device using entity starts the edge device 12 operation. The edge device 12 that has started operation moves by an automatic operation such as automatic driving, is charged or refueled, or is temporarily stopped in a parking lot.

(Step S1C02) The edge device 12 (more specifically, the in-edge controller 10, and even more specifically, the state data diagnosis unit 110) detects (or diagnoses) that the edge device 12 is in an abnormal state. After that, the diagnosis described by the state data diagnosis unit 110 is performed, and the ECTL diagnostic data is transmitted. FIG. 6 illustrates a case where the data is transmitted via the diagnostic data management cloud (flow of data flows D11 and D26). This flow has the advantage of being able to transmit in more real-time than via the edge data distribution company cloud 24 but other routes may also be used.

(Step S1D01) The analysis outsourcing cloud 27 receives the ECTL diagnostic data. Then, the cause analysis process unit 8 analyzes the causes of the abnormal state indicated by the ECTL diagnostic data.

(Step S1D02) The analysis outsourcing cloud 27 transmits the post-analysis data of step S1D01 to the edge device using entity, the edge device manufacturing company computer, and the diagnostic data management cloud 26. The content of the post-analysis data may differ depending on whether the data is transmitted to the edge device using entity or the edge device manufacturing company computer. As shown in FIG. 6, the transmission routes are the data flows D22, D26, and D27. A specific example of the data already described may be transmitted in this step.

(S1C03) The edge device using entity recovers the edge device 12 while referring to the received post-analysis data.

(S1B03) The diagnostic data management cloud (more specifically, the diagnostic circuit and control update unit) updates the diagnostic circuit or the diagnostic program based on the received post-analysis data so as to reduce the occurrence of abnormal states. Then, the updated diagnostic circuit or diagnostic program is transmitted to the edge device manufacturing company. The diagnostic data management cloud 26 may update the diagnostic sequence in this step or may update or propose to update a part of the design data 13 whose design is handled by the edge device manufacturing company. It can be said that the diagnostic circuit and the diagnostic program updated in this way are improved data.

(S1A03) The edge device manufacturing company creates the design data 13 for the next-generation edge device 12 based on the received post-analysis data. The creation may be based on improved data by the edge device manufacturing company.

As a process after the flow of FIG. 6, the edge device manufacturing company may generate the diagnostic sequence in step S1B01 based on the data D26 and update the diagnostic sequence (that is, an improved diagnostic sequence). The improved diagnostic sequence is also one of the improved data. In addition, when the edge device manufacturing company updates the function to solve the design problems and precautions of the edge device 12, the edge device manufacturing company can transmit the update data to the edge data distribution company cloud 24. Thus, the update data can be transmitted to the edge device 12 to improve the function and solve the problem.

The above is the explanation of the flow. With this solution, the edge device usage entity can recover from an abnormality more quickly. In addition, the edge device manufacturing company will be easier to design a next-generation edge device that reduces the occurrence of abnormalities.

<Second Solution (for Dealers or Repair Companies)>

The distributed system 1000 can provide the ECTL diagnostic data and the post-analysis data to the dealer or the repair company and the solution will be described below with an example. This example is merely an example of a mode in which the distributed system 1000 according to the present invention is used and does not limit the applicable range of the present invention.

This example basically has the same configuration as the solution for the edge device manufacturing company described above. Therefore, duplicate descriptions will be omitted and the different points will be mainly described. The diagnostic data cloud 32 provides the dealer or the repair company of the edge device 12 with repair information (parts to be replaced, and replacement schedule) in addition to the post-analysis data of the cause analysis.

<<Flow of Cooperation Among Computers, Clouds, and Edge Devices>>

FIG. 8 is a diagram showing the flow of cooperation among the computer, the cloud, and the edge device in a second solution.

Each will be described below. The same portions as those in the first solution (particularly the portions having the same numbers in the drawing) will not be described. In the following example, assuming that the edge device using entity is a MaaS or rental company, an alternative device is lent to the entity for the edge device in which the abnormality has occurred, but may not be the case. That is, the user may not replace the edge device 12 and may wait until the dealer or the repair company completes the repair.

(Step S1D01) The analysis outsourcing cloud 27 receives the ECTL diagnostic data. Then, the cause analysis process unit 8 analyzes the causes of the abnormal state indicated by the ECTL diagnostic data. The analysis content may be the same as or different from that of the first solution. In this solution, as a part of the cause analysis process, the parts (components) to be replaced included in the edge device 12 are identified. Further, the cause analysis process may estimate the estimated replacement time of the part, or the time required for the part to arrive at the dealer or the repair company from the edge device manufacturing company. In the following description, the information on the parts to be replaced and the estimated time will be described as being included in the post-analysis data.

(Step S1D02) The analysis outsourcing cloud 27 transmits the post-analysis data of step S2D01 to the dealer or repair company cloud 28. The transmission route is the data flow D32 as shown in FIG. 8.

(Step S2C03) The edge device specification entity replaces the edge device 12. The replaced edge device 12 with an abnormal state is sent to the dealer or the repair company. In FIG. 8, the dealer or repair company cloud does not arrange for an alternative edge device. In addition, the edge device specification entity uses an alternative edge device.

(Step S2E01) Upon receiving the post-analysis data, the dealer or the repair company checks the inventory of parts, and if the part is out of stock, requests the edge device manufacturing company to send the part. In addition, this determination may be made before the edge device 12 in which the abnormality has occurred arrives at the dealer or the repair company. In particular, if the edge device is a moving body and cannot move due to an abnormality, it may take a long time because it may be necessary to move the moving body with a tow truck from the location where the abnormality occurred to the premises of the dealer or the repair company. Arrangements triggered by such post-analysis data reception can shorten the repair time. In addition, by leveraging the estimated time, the dealer or repair company cloud can perform repairs more systematically. The dealer or the repair company then repairs the edge device 12.

(Step S2E02) The dealer or repair company sends the repaired edge device 12 to the edge device using entity. The entity at this time may be different from the entity before the replacement or may be the same.

(Step S2C04) The edge device using entity starts the operation of the repaired edge device 12.

<<Data Screen After Cause Analysis Process>>

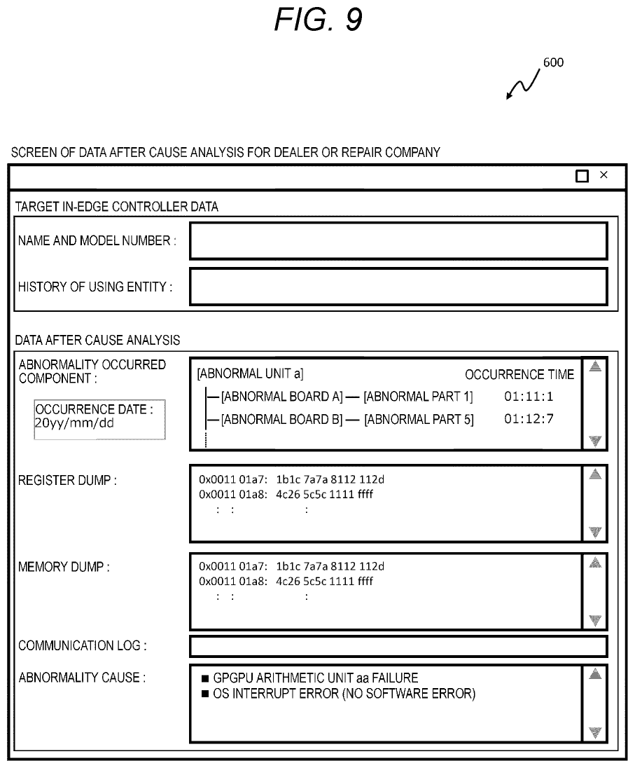

FIG. 9 is a diagram showing an example of a data screen 600 after cause analysis for dealers or repair companies. The information displayed on the screen may be considered to be included in the post-analysis data transmitted in step S2D02. The screen is used by an employee of a dealer or a repair company. The screen is realized as a Web application.

The data screen 600 after cause analysis for dealers or repair companies includes an area for displaying the name and model number indicating the edge device subject to cause analysis, an area for displaying the history of the using entity, and an area for displaying post-analysis data. Hereinafter, each area will be described.
In the area for displaying the name and model number, for example, when the edge device subject to cause analysis is an automobile, the vehicle type, model, or configuration information ID is displayed.
In the area for displaying the using entity, the ID of the entity that used the edge device is displayed in the history format. Other histories (for example, operation start date, or maintenance history) may be displayed in this area.

In the area for displaying the data after the cause analysis process, for example, the following regarding the edge device 12 is displayed. Not all displays are required.
ID of the component in the abnormal state.
The date and time when the abnormal state occurred.
Register dumps and memory dumps that indicate register values and memory values acquired by the diagnostic circuit and diagnostic program during diagnosis. These values are for experts.
Communication log.
Information indicating the cause of the abnormality.

Here, the abnormality cause includes information for determining whether the abnormality is a software abnormality or a hardware abnormality according to the abnormality cause that has occurred. This is because the methods of resolving a software abnormality and a hardware abnormality often differ greatly.

As mentioned above, according to this solution, the dealer or the repair company can quickly grasp that the edge device is in an abnormal state and needs to be repaired. Also, since the dealer or the repair company does not need to use the design data to identify the parts that need to be replaced, a wider range of people can engage in the repair.

<Third Solution (for Insurance Companies)>

The distributed system 1000 can provide the ECTL diagnostic data and the post-analysis data to the insurance company and the solution will be described below with an example. This example is merely an example of a mode in which the distributed system 1000 according to the present invention is used and does not limit the applicable range of the present invention.

This example basically has the same configuration as the solution for the edge device manufacturing company described above. Therefore, duplicate descriptions will be omitted, and the different points will be mainly described. The diagnostic data cloud 32 is assumed to provide the insurance company related to the edge device 12 with statistical information such as the cause and frequency of occurrence of the detected abnormality as a part of the post-analysis data of the cause analysis. In the following description, the money paid by the insurance company is referred to as insurance payout, and the money paid by the contracting entity to the insurance company is referred to as insurance premium.

<<Insurance Company Cloud>>

The insurance company cloud 29 in this solution stores the following data as a storage resource.
Contract condition data: Data showing contract conditions corresponding to the specifications of insurance services. The data stores the conditions stipulated in the insurance contract, such as insurance payout conditions (including the amount), insurance premiums, and contract period.
Contracting entity data: Data related to the contracting entity. The data stores the name of the entity, the ID indicating applicable contract conditions, and a contract start date. In the case of an insurance service that is applied only when the contracting entity uses a specific edge device 12, data (for example, a vehicle number) that identifies the edge device 12 may be included.

The data may store entity-related data for sales activities that are not directly related to the contract.
Insurance payout history data: Data related to insurance payout history. The data stores the payout date, insurance payout amount, the ID of the contracting entity to be paid, the ID of contract conditions, and data used to determine the insurance payout amount (for example, data indicating what kind of abnormality or accident occurred).
Insurance premium receipt history: Data related to insurance premium receipt history. The data stores the date of receipt, the insurance premium, the ID of the contracting entity that is the payment source, and the ID of the contract conditions.

Not all the data in the above description is essential and it is not necessary for each data to be stored in strictly separate tables or storage areas.

In the insurance company cloud, a program for providing insurance services by the insurance company (hereinafter referred to as the insurance service program) is executed. The insurance service program receives the data that is the basis of the above data from the contract target or the like, and updates these data according to the receipt of insurance premiums and the insurance payout.

The insurance company cloud 29 further executes a contract condition analysis program. This program is a program that performs the analysis process necessary for revising the contract conditions by accessing the above data. The contract condition analysis program may perform the following processes, for example.
Using the above data, estimate the number of insurance contracts, the total insurance premiums based on the number of contracts, and the total insurance payout amount, assuming a prescribed contract condition.
Using the above data, calculate a draft contract condition that is suitable for the case assuming management indicators such as the profit amount or profit rate of the insurance company.

<<Flow of Cooperation Among Computers, Clouds, and Edge Devices>>

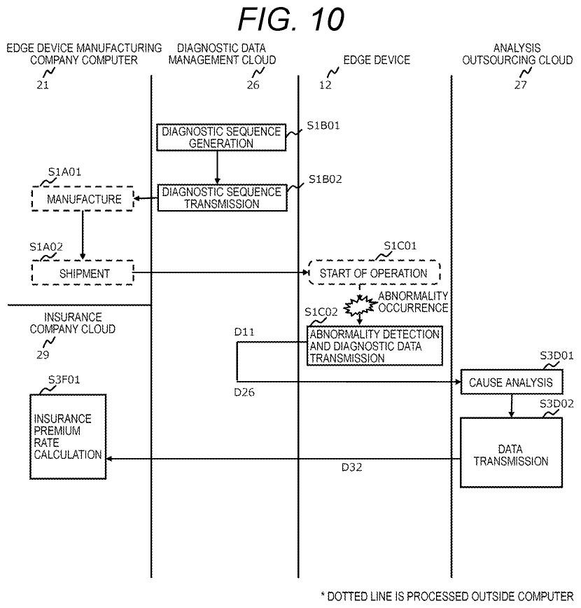

FIG. 10 is a diagram showing the flow of cooperation among the computer, the cloud, and the edge device in a third solution. Each will be described below. The same portions as those in the first and second solutions (particularly the portions having the same numbers in the figure) will not be described.

(Step S3D01) The analysis outsourcing cloud 27 receives the ECTL diagnostic data. Then, the cause analysis process unit 8 analyzes the causes of the abnormal state indicated by the ECTL diagnostic data. The analysis content may be the same as or different from the first and second solutions. In this solution, statistical information such as the cause and frequency of occurrence of the detected abnormality is provided as a part of the cause analysis process.

(Step S3D02) The analysis outsourcing cloud 27 transmits the post-analysis data of step S2D01 to the insurance company cloud 29. The transmission route is D32 as shown in FIG. 8.

(Step S3F01) The insurance company cloud (more specifically, the contract condition analysis program) calculates a revised proposal for insurance contract conditions using the received post-analysis data and the above-mentioned data stored in the storage resource.

The above is the flow. As for the insurance contract conditions, even if the insurance premium is low, the contracting entity will not reach the contract if the conditions for the insurance payout are strict. On the other hand, if the conditions for the insurance payout are mild too much, the income and expenditure of the insurance company will deteriorate too much and the service cannot be continued. Based on the processed data provided by the analysis outsourcing cloud, the conditions for the insurance payout can be set in consideration of the frequency of occurrence of abnormal states inside the in-edge controller 10. For example, if a specific condition (for example, type of edge device 12, usage environment, type of using entity) causes a high frequency of abnormal states inside the in-edge controller, the insurance premium for that condition can be increased, and on the contrary, the insurance premium is lowered under the condition where the frequency of occurrence is low, thereby making it possible to optimize the insurance premium. This advantage becomes a greater advantage when there are many abnormalities related to the in-edge controller 10 due to the spread of automatic operation.

<Fourth Solution (for Rental Companies or MaaS Companies)>

The second solution for the dealer or repair company can also be applied to a rental company or a MaaS company. However, the rental company or the MaaS company does not make detailed repairs to the edge device 12 as compared with the dealer or the repair company. On the other hand, in the case of a service provided by a rental company or a MaaS company, an appropriate cost can be obtained from a user of the service because the edge device 12 is operating normally. Therefore, the recovery time from the abnormal state of the edge device 12 becomes shorter.

Therefore, it is preferable to customize the information provided to the rental company or the MaaS company by this solution. Regarding this solution, first, a data screen 700 after cause analysis for a rental company or a MaaS company will be described focusing on the difference.

<<Data Screen After Cause Analysis>>

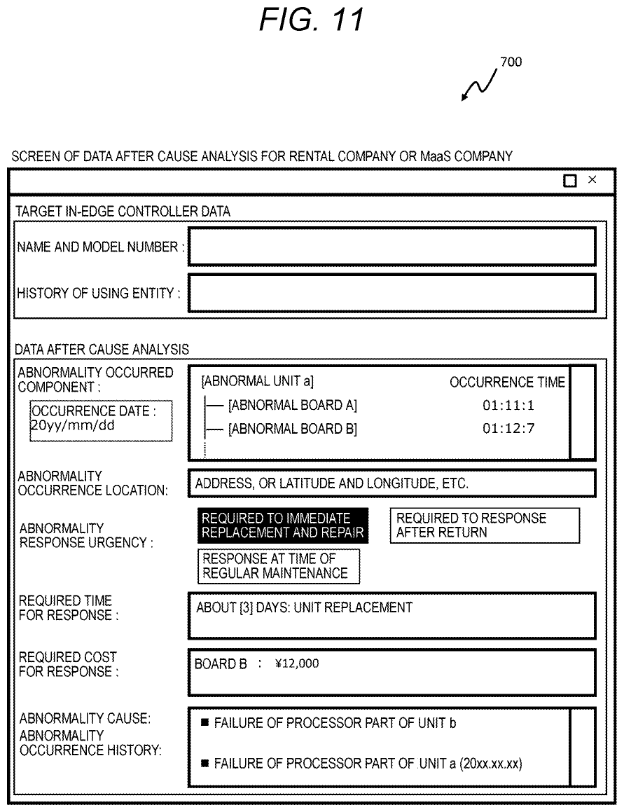

FIG. 11 is a diagram showing an example of the data screen 700 after cause analysis for a rental company or a MaaS company. The screen is used by an employee of a rental company or a MaaS company. The screen is realized as a Web application. Since the screen of FIG. 11 has the same information as the data screen after cause analysis of FIG. 9 (for dealers or repair companies), the different points will be mainly described. The screen is a screen displayed on the rental company or MaaS company cloud 22 by the process of the analysis outsourcing cloud 27.

The data screen 700 after cause analysis includes an area for displaying the name and model number indicating the edge device subject to cause analysis, an area for displaying the history of the using entity, and an area for displaying the post-analysis data. Hereinafter, each area will be described.
In the area for displaying the name and model number, for example, when the edge device subject to cause analysis is an automobile, the vehicle type, model, or configuration information ID is displayed.
In the area for displaying the using entity, the ID of the entity that used the edge device is displayed in the history format. Other histories (for example, operation start date, or maintenance history) may be displayed in this area.

In the area for displaying the data after the cause analysis process, for example, the following regarding the edge device 12 is displayed. Not all displays are required.
ID of the component in the abnormal state.
The date and time when the abnormal state occurred.
Location where an abnormal state occurs.
Urgency for dealing with abnormal states.
Required period for responding to the abnormal state.
Cost required to deal with the abnormal state.
Information indicating the cause of the abnormality.
History of the occurrence of abnormal states.

Here, the information for further shortening the recovery time from the abnormal state of the edge device 12 is the location, the urgency, and the required response time. The rental company or the MaaS company can select an appropriate recovery method in consideration of these factors. The recovery method that is possible by providing the screen is, for example, as follows.
The recovery work is performed with a priority on the edge device whose location where the abnormal state occurred is farther from the base location of the rental company or the MaaS company. An example in which the priority is reflected is the arrangement of an alternative edge device 12.
Resolve the low urgency abnormal state before it becomes the high urgency abnormal state. In the case of this solution, the degree of urgency response can be finely determined based on the internal state of the in-edge controller 10 and, thus, such a response becomes possible. The urgency may be determined by performing a correlation analysis of the ECTL diagnostic data as an analysis process in the analysis outsourcing cloud 27, obtaining the correlation as the post-analysis data, and considering the correlation in the urgency setting. For example, if an abnormal state is not fatal to the in-edge controller 10 by itself, the priority can be lowered, but if the abnormal state with high correlation has a high urgency, the former abnormal state is set to medium or high, which is higher than low.
Prioritize recovery work based on urgency. In particular, when abnormal states having different degrees of urgency occur in the same edge device 12, the abnormal state having a low urgency may be resolved by resolving the abnormal state having a high urgency.

<<Flow of Cooperation Among Computers, Clouds, and Edge Devices>>

The flow of cooperation among the computer, the cloud, and the edge device is as described in FIG. 8 related to the second solution. However, since the screen described in FIG. 11 is executed in step S2D01 performed in the analysis outsourcing cloud 27, the cause analysis process performed in the step includes a process of generating the information described in FIG. 11. Needless to say, the data transmitted by step S2D02 related to data transmission includes the information described with reference to FIG. 11.

<Variation>

This concludes the explanation of each solution. The present invention is not limited to the above embodiments and includes various modifications as follows.

The data output by the in-edge controller 10 as ECTL diagnostic data does not necessarily have to be in an abnormal state or a state of a hardware component. For example, in addition to the current state of software, the history of past processes (for example, neural network parameters and hyperparameters, learning states of other machine learning, and in the case of an automatic driving program, the automatic driving rule that is the reason for giving predetermined control to the moving or operating mechanism, and the location (name) of the branching process) may be included in the ECTL diagnostic data.

Further, although it has been described above that a company has a cloud that provides a predetermined service, it is not always necessary for the company to own the hardware resources that constitute the cloud. Similarly, it is not necessary for the company to own a part or all of the program for providing the prescribed service.

It is possible to replace a part of the configuration of one embodiment with the configuration of another embodiment. It is also possible to add the configuration of another embodiment to the configuration of one embodiment.

It is possible to add, delete, and replace a part of the configuration of the embodiment with another configuration.

Each of the above configurations, functions, processing units, processing means, and the like may be realized by hardware by designing a part or all of them by, for example, an integrated circuit. Further, each of the above configurations, functions, and the like may be realized by software by the processor interpreting and executing a program that realizes each function. Information such as programs, tables, and files that realize each function can be placed in a memory, a recording device such as a hard disk or SSD, or a recording medium such as an IC card, SD card, or DVD.

The control lines and information lines are those that are considered necessary for the explanation, and not all control lines and information lines are shown on the product. In reality, it may be considered that almost all configurations are connected to each other by a communication network, a bus, or the like.

The technique according to the present invention is not limited to the distributed system and can be provided in various forms such as a computer, a computer-readable program, and a distributed processing method.

### SUMMARY

As mentioned above, the following has been explained in this specification. Since the cloud server is composed of at least one computer, the computer will be described as a representative.

<<Viewpoint 1>>

A distributed system including an edge device, which is a moving body or equipment capable of automatic operation, a diagnostic data computer, and a manufacturing company computer, which is a computer owned by a manufacturing company of the edge device, where the edge device includes a moving mechanism or an operating mechanism for automatic operation and an in-edge controller that controls the moving mechanism or the operating mechanism, and the diagnostic data computer: receives diagnostic data indicating an internal state in the in-edge controller, performs a cause analysis process of the state in the in-edge controller based on the diagnostic data, and transmits the data after the cause analysis process or improved data for the edge device based on the result of the cause analysis process to the manufacturing company computer.

<<Viewpoint 2>>

The distributed system described in viewpoint 1, wherein the diagnostic data computer stores an analysis rule storing the causal relationship of the state generated in the edge device in a storage resource, and the diagnostic data computer refers to the analysis rule during the cause analysis process.

<<Viewpoint 3>>

The distributed system described in viewpoint 1, wherein when the diagnostic data computer transmits the improved data to the manufacturing company computer, the improved data is the next-generation design data of the edge device.

<<Viewpoint 4>>

The distributed system described in viewpoint 1, wherein when the diagnostic data computer transmits the improved data to the manufacturing company computer, the improved data is improved data of the in-edge controller, and the manufacturing company computer transmits the improved data to the edge device.

<<Viewpoint 5>>

The distributed system described in viewpoint 4, further including an edge data distribution company computer, which receives the improved data from the manufacturing company computer and transmits the improved data to the edge device, wherein the edge data distribution company computer: receives the diagnostic data from the diagnostic data computer, stores the diagnostic data in a storage resource, processes the diagnostic data stored in the storage resource according to a predetermined schedule, and transmits the processed diagnostic data to a service provider computer, which is a computer of a company that provides a predetermined service.

<<Viewpoint 6>>

The distributed system described in viewpoint 1, wherein the diagnostic data computer: transmits the data after the cause analysis process or the data for identifying the cause of an abnormality of the edge device based on the result of the cause analysis process to a service provider computer, which is a computer of a company that provides a predetermined service.

<<Viewpoint 7>>

The distributed system described in viewpoint 1, wherein the diagnostic data computer: transmits the data after the cause analysis process or data for identifying a part that is the cause of an abnormality of the edge device and a replacement schedule of the part based on the result of the cause analysis process to the service provider computer, which is a computer of a company that provides a predetermined service.

<<Viewpoint 8>>

A distributed system including an edge device, which is a moving body or equipment capable of automatic operation, a service provider computer, which is a computer of a company that provides a predetermined service, and an analysis outsourcing computer, wherein the edge device includes a moving mechanism or an operating mechanism for automatic operation and an in-edge controller that controls the moving mechanism or the operating mechanism, and the analysis outsourcing computer: performs a service-related analysis process, which is an analysis process related to the predetermined service, based on the state of the in-edge controller, and transmits the data after the service-related analysis process obtained in the service-related analysis process to the service provider computer.

<<Viewpoint 9>>

The distributed system described in viewpoint 8, wherein the company that provides the predetermined service is a company that does not design or manufacture the edge device or components of the edge device.

<<Viewpoint 10>>

The distributed system described in viewpoint 8, wherein the predetermined service is a repair service for the edge device, the service-related analysis process is a process for identifying the cause of a predetermined internal state of the in-edge controller, and the data after the service-related analysis process is a process of generating repair information that resolves the cause.

<<Viewpoint 11>>

The distributed system described in viewpoint 8, wherein the predetermined service is an insurance service related to the edge device, and the data after the service-related analysis process includes information on the frequency of occurrence of an abnormal state of the edge device.

<<Viewpoint 12>>

A distributed system including an edge device, which is a moving body or equipment capable of automatic operation, a diagnostic data management computer, an analysis outsourcing computer, an edge data distribution company computer, and a service provider computer, which is a computer of a company that provides a predetermined service, wherein the edge device includes a moving mechanism or an operating mechanism for automatic operation and an in-edge controller that controls the moving mechanism or the operating mechanism, and the diagnostic data management computer: receives diagnostic data indicating the state in the in-edge controller, transmits the diagnostic data to the edge data distribution company computer, and transmits the diagnostic data to the analysis outsourcing computer according to a first schedule, the edge data distribution company computer: receives the diagnostic data from the diagnostic data management computer, stores the diagnostic data in a storage resource, processes the diagnostic data stored in the storage resource according to a second schedule having an interval longer than the first schedule, and transmits the processed diagnostic data to the service provider computer, and the analysis outsourcing computer: performs a service-related analysis process, which is an analysis process related to the predetermined service, based on the state of the in-edge controller, and transmits the data after the service-related analysis process obtained by the service-related analysis process to the service provider computer.

<<Viewpoint 13>>

The distributed system described in viewpoint 12, wherein the analysis outsourcing computer is owned by the same data center or the same company as the diagnostic data management computer.

<<Viewpoint 14>>

A distributed system including an edge device, which is a moving body or equipment capable of automatic operation, a diagnostic data computer, and a manufacturing company computer, which is a computer owned by a manufacturing company of the edge device, wherein the edge device includes a moving mechanism or an operating mechanism for automatic operation and an in-edge controller that controls the moving mechanism or the operating mechanism, and the diagnostic data computer receives diagnostic data indicating an internal state in the in-edge controller, and transmits the diagnostic data or the processed diagnostic data to another computer.

What is claimed is:

1. A distributed system comprising:
an edge device, which is a moving body or equipment capable of automatic operation;
a diagnostic data computer; and
a manufacturing company computer, which is a computer owned by a manufacturing company of the edge device, wherein
the edge device includes a moving mechanism or an operating mechanism for automatic operation and an in-edge controller that controls the moving mechanism or the operating mechanism, and
the diagnostic data computer:
receives diagnostic data indicating an internal state in the in-edge controller,
performs a cause analysis process of the state in the in-edge controller based on the diagnostic data, and
transmits the data after the cause analysis process or improved data for the edge device based on the result of the cause analysis process to the manufacturing company computer.

2. The distributed system according to claim 1, wherein
the diagnostic data computer stores an analysis rule storing a causal relationship of the state generated in the edge device in a storage resource, and
the diagnostic data computer refers to the analysis rule during the cause analysis process.

3. The distributed system according to claim 1, wherein
when the diagnostic data computer transmits the improved data to the manufacturing company computer, the improved data is the next-generation design data of the edge device.

4. The distributed system according to claim 1, wherein
when the diagnostic data computer transmits the improved data to the manufacturing company computer, the improved data is improved data of the in-edge controller, and
the manufacturing company computer transmits the improved data to the edge device.

5. The distributed system according to claim 4, further comprising:
an edge data distribution company computer, which receives the improved data from the manufacturing company computer and transmits the improved data to the edge device, wherein
the edge data distribution company computer:
receives the diagnostic data from the diagnostic data computer,
stores the diagnostic data in a storage resource,
processes the diagnostic data stored in the storage resource according to a predetermined schedule, and
transmits the processed diagnostic data to a service provider computer, which is a computer of a company that provides a predetermined service.

6. The distributed system according to claim 1, wherein
the diagnostic data computer:
transmits the data after the cause analysis process or the data for identifying the cause of an abnormality of the edge device based on the result of the cause analysis process to a service provider computer, which is a computer of a company that provides a predetermined service.

7. The distributed system according to claim 1, wherein
the diagnostic data computer:
transmits the data after the cause analysis process or data for identifying a part that is the cause of an abnormality of the edge device and a replacement schedule of the part based on the result of the cause analysis process to the service provider computer, which is a computer of a company that provides a predetermined service.

8. A distributed system comprising:
an edge device, which is a moving body or equipment capable of automatic operation;
a service provider computer, which is a computer of a company that provides a predetermined service; and
an analysis outsourcing computer, wherein
the edge device includes a moving mechanism or an operating mechanism for automatic operation and an in-edge controller that controls the moving mechanism or the operating mechanism, and
the analysis outsourcing computer:
performs a service-related analysis process, which is an analysis process related to the predetermined service, based on a state of the in-edge controller, and
transmits the data after the service-related analysis process obtained in the service-related analysis process to the service provider computer.

9. The distributed system according to claim 8, wherein
the company that provides the predetermined service is a company that does not design or manufacture the edge device or components of the edge device.

10. The distributed system according to claim 8, wherein
the predetermined service is a repair service for the edge device,
the service-related analysis process is a process for identifying the cause of a predetermined internal state of the in-edge controller, and
the data after the service-related analysis process is a process of generating repair information that resolves the cause.

11. The distributed system according to claim 8, wherein
the predetermined service is an insurance service related to the edge device, and
the data after the service-related analysis process includes information on the frequency of occurrence of an abnormal state of the edge device.

12. A distributed system comprising:
an edge device, which is a moving body or equipment capable of automatic operation;
a diagnostic data management computer;
an analysis outsourcing computer;
an edge data distribution company computer; and
a service provider computer, which is a computer of a company that provides a predetermined service, wherein
the edge device includes a moving mechanism or an operating mechanism for automatic operation and an in-edge controller that controls the moving mechanism or the operating mechanism, and
the diagnostic data management computer:
receives diagnostic data indicating a state in the in-edge controller,
transmits the diagnostic data to the edge data distribution company computer, and
transmits the diagnostic data to the analysis outsourcing computer according to a first schedule,
the edge data distribution company computer:
receives the diagnostic data from the diagnostic data management computer,
stores the diagnostic data in a storage resource,
processes the diagnostic data stored in the storage resource according to a second schedule having an interval longer than the first schedule, and
transmits the processed diagnostic data to the service provider computer, and
the analysis outsourcing computer:
performs a service-related analysis process, which is an analysis process related to the predetermined service, based on the state of the in-edge controller, and
transmits the data after the service-related analysis process obtained by the service-related analysis process to the service provider computer.

13. The distributed system according to claim 12, wherein
the analysis outsourcing computer is owned by the same data center or the same company as the diagnostic data management computer.

14. A distributed system comprising:
an edge device, which is a moving body or equipment capable of automatic operation;
a diagnostic data computer; and
a manufacturing company computer, which is a computer owned by a manufacturing company of the edge device, wherein
the edge device includes a moving mechanism or an operating mechanism for automatic operation and an in-edge controller that controls the moving mechanism or the operating mechanism, and
the diagnostic data computer receives diagnostic data indicating an internal state in the in-edge controller, and
transmits the diagnostic data or the processed diagnostic data to another computer.
